(19) United States
(12) Patent Application Publication
(10) Pub. No.: US 2016/0222946 A1
(43) Pub. Date: Aug. 4, 2016

(54) SYSTEM AND METHOD FOR DETERMINING MOVEMENTS AND OSCILLATIONS OF MOVING STRUCTURES

(71) Applicant: NORTHROP GRUMMAN LITEF GMBH, Freiburg (DE)

(72) Inventor: MANFRED KRINGS, MARCH (DE)

(73) Assignee: NORTHROP GRUMMAN LITEF GMBH, FREIBURG (DE)

(21) Appl. No.: 14/915,774

(22) PCT Filed: Aug. 28, 2014
(86) PCT No.: PCT/EP2014/002345

§ 371 Date: Mar. 1, 2016

(30) Foreign Application Priority Data
Sep. 2, 2013 (DE) 10 2013 014 622.4

(51) Int. Cl. F03D 17/00; G01C 19/02; F03D 9/00; G01C 21/16; G01C 21/20; F03D 3/00; G01P 15/02; G01M 99/00

(52) U.S. Cl. CPC F03D 17/00; G01P 15/02; G01C 19/02; G01M 99/00; G01C 21/16; G01C 21/20; F03D 3/002; F03D 9/002

(57) ABSTRACT

The invention relates to a system for monitoring movements of a structure (1), which system comprises at least one inertial measurement device (5), mounted on said structure, for detecting rotation rates and acceleration values in the earth-fixed inertial system. A central unit (11) determines a monitoring value on the basis of the rotation rates and acceleration values, using a navigation algorithm. The invention further relates to an output unit (12) for outputting the monitoring value.

The invention concerns a system and a method for monitoring of movements of a structure.

Movable structures as, for example, buildings and large machines may be set into motions or oscillations by environmental influences or by their own operational movements, which may damage the structure or hinder the operation. To prevent damages, to plan maintenance, or to estimate the residual lifetime such movements can be observed and monitored.

For monitoring of wind turbines known sensors such as uniaxial acceleration sensors with piezo technology, strain gauges, photometry systems or laser measuring systems are used. By these means, simple position changes and frequency analysis of the structure-born sound can be carried out, which allow a detection of possible damages of parts of the turbine such as bearings, gear parts or rotor blades.

Here, there is a disadvantage that the measured values detect a movement of the system only uniaxially and only for selected measurement locations.

It is an object of the invention to provide a system and a method for monitoring of movements of a structure that allow an effective and secure monitoring of the structure and that provide a basis for repair measures, maintenance planning, and/or estimation of the residual lifetime of parts of the structure.

This object is solved by a system according to claim 1 for monitoring of movements of a structure and a method according to a further independent claim for monitoring of movements of a structure. Further embodiments are indicated in the dependent claims.

A system for monitoring of movements of a structure comprises at least one inertial measurement device, mounted on said structure, for detecting of rotation rates and acceleration values in the earth-fixed inertial system. The system further comprises a central unit for determining a monitoring value on the basis of the rotation rate and the acceleration value by means of a navigation algorithm and an output unit for outputting of the monitoring value.

The structure may be an arbitrary object that can be set into motion and/or oscillations by means of outer influences (environmental influences) or inner influences (operating behavior). For example, it might be a building, such as a multi-story building or a transmission tower, or it might be a machine, such as a construction machine, a crane or the like. Further, it might also be a structure that is constructed like a building and operated like a machine, such as for example a Ferris wheel, an offshore platform or a wind turbine.

On the one hand, such structures may be set into motions by environmental influences such as wind, sea current, wave impact or movements of the surface of the earth, e.g. during an earth quake. On the other hand, such structures may also be set into motions by their own operational movements such as a working motion of a part of the structure, drive oscillations or gear vibrations. Moreover, interactions may be present between environmental influences and internal movements of the structures, which may lead to a complex motion behavior.

Such movements and oscillations may damage the structure and may lead to material fatigue such as fatigue cracks or fractures. Furthermore, they may influence the operating behavior of the structures and limit in this manner the field of applications or the operation efficiency.

Further, it is also possible that the structure changes during time, for example by aging, wear-out, structural damages, mechanical damages or by environmental influences. For example, in complex moving structures such as wind turbines icing on or water accumulation in the rotor blades may occur. Due to stress and material fatigue the material characteristics may change, parts of the structure may become softer or get cracks. Such changes of the structure are reflected in the motion behavior of the structure. For example, frequency or amplitudes of oscillations or movements may change. The changes can be detected based on the rotation rates and acceleration values measured by the inertial measurement device. This allows recognizing the necessity of measures for example for maintenance, upkeep or operation and to carry out such measures before significant damages occur.

Therefore, monitoring of movements of the structure is required for reasons of operation safety as well as operation efficiency.

For monitoring of the movements one or more inertial measurement devices may be fixed on the structure or a part of the structure, which allow to detect the rotation rates and acceleration values occurring on the mounting positions with respect to the earth fixed inertial system. To this end, systems with inertial sensors (acceleration and rotation rate sensors) of MEMS—(micro-electro-mechanical systems) and/or FOG IMU—(fiber optic gyro inertial measurement units) type may be used.

The detected acceleration values and rotation rates may be transmitted to the central unit, for example via a wireless or wire-bound network for uni- or bidirectional communication.

In the central unit velocities and angular velocities as well as an orientation and a position of the inertial measurement device within space may be determined on the basis of the measured rotation rates and acceleration values by means of a navigation algorithm, for example by means of continuous integration or summation of the measured rotation rates and accelerations.

To this end, typical navigation algorithms may be used, which are known for example from the fields of vehicle, chip and/or flight navigation, e.g. with a Schuler compensation of the detected rotation rates and accelerations.

On the basis of the measured rotation rates and acceleration values, the calculated (angular) velocities, the orientation and/or position movements of the structure can be detected and monitored. In particular, the movements, oscillations and deflections present at the measurement locations can be determined.

Further, based on this the monitoring value can be determined. The monitoring value may for example comprise the measured rotation rate, the measured acceleration value, the calculated (angular) velocity, orientation and/or position or a further value deduced therefrom such as a frequency and/or amplitude of movement, torsion and/or deflection.

The monitoring value may be transmitted by means of wireless or wire-bound communication to the output unit. The output unit may comprise in a most simple case a display for outputting the monitoring value or its evolution, but it may also comprise further components such as a data storage for collecting and documenting the evolution of the monitoring value in dependence of time. Alternatively or additionally the output unit may comprise a complex warning and alarm system.

In addition it is possible to couple the output unit in the manner of a control loop system with actuators of the structure. In this case depending on the monitoring value control information, such as actuating variables, may be transmitted to the actuators. In case of monitoring a wind turbine it is for example possible to control a relative orientation of the rotor blades depending on a monitoring value that allows determining of bending of the rotor blades to avoid an excessive load on the rotor blades.

Based on the monitoring value as well as on further monitoring information it is possible to determine movements and oscillations of the structure and, hence, for example possible malfunctions, fatigues or damages. This allows for example estimating of the residual lifetime of the structure or its components and may be used as basis for maintenance planning. Such estimations are in particular helpful for monitoring of structures that are difficult to access (e.g. offshore wind turbines) and for machines with high working load (presses of a large pressing plant), for which each maintenance is connected with high costs. Further, such characteristic values are important in view of security requirement, as the continuous monitoring is regularly documented and need for maintenance is indicated immediately.

According to an embodiment the inertial measurement device comprises three rotation rate sensors with detection axes that are linearly independent of each other and/or orthogonal to each other, respectively, as well as three acceleration sensors with detecting directions that are linearly independent with respect to each other and/or orthogonal to each other, respectively.

For example, the rotation rate sensors may comprise three detection axes x, y, and z, which are orthogonal to each other and correspond to the detecting directions of the acceleration sensors. By means of the rotation rate sensors (the gyroscope sensors) the rotational movement can be calculated, while by means of the acceleration sensors (the translational sensors) the translational movement can be calculated. Thus, arbitrary movements of the inertial measurement device according to the six degrees of freedom can be determined.

According to an embodiment the central unit is configured to determine and/or correct a measurement error of the inertial measurement device on the basis of a boundary condition predetermined by the structure.

In particular, classical inertial navigation that starts from a predetermined inertial position undergoes a continuous increase of the orientation or position error that results from integrating or summing up of possible errors or measurement imprecisions (e.g. zero point error) of the inertial sensors (rotation rate and acceleration sensors). This increase is called drift.

To restrict or to compensate a drift of the position and orientation and hence also of the monitoring value, stable requirements and conditions, which are present for the structure, can be taken into account during application of the navigation algorithm. These conditions may for example be incorporated into the navigation in the form of boundary conditions. Thus, the navigation algorithm may be supported by these requirements and conditions. An error in the calculation result or an error of the monitoring value can be estimated and/or compensated on this basis.

Taking into account boundary conditions may comprise in the simplest case a comparison of the boundary condition (e.g. a known geographical position of the structure) with calculated values (velocity, angular velocity, position and orientation). On this basis the error (e.g. zero point error) of the inertial measurement device (rotation rate and acceleration sensors) can be estimated and the precision of the measurement can be continuously improved. For example, taking into account several or complex boundary conditions may be realized by means of a Kalman filter within the navigation algorithm.

According to a further embodiment the central unit may be configured to determine the boundary conditions on the basis of at least one information of a group comprising a substantially stationary position of the structure, a position of at least a part of the structure determined on the basis of a satellite based positioning signal, a constraint of a degree of freedom of a movement of at least a part of the structure, an inclination angle of at least a part of the structure, a mean value of a movement of at least a part of the structure and/or the inertial measurement device (for example predetermined or derivable from the measurement values or calculated values), and of a wind velocity, wind direction, current velocity, current direction and/or wave impact direction acting on the structure.

Thus, the actual conditions of the structure and its arrangement in the environment as well as any kind of knowledge about environmental conditions can be used to support the navigation algorithm or to estimate or correct the drift in position or orientation.

Such boundary conditions are not known in classical vehicle navigation, as they are in principal not present for vehicles. In the context of classical vehicle navigation they are therefore not used for error correction or avoidance of drift. During monitoring of moving structures, which may for example be arranged stationary, such conditions may, however, be present and can be used for error correction.

Error estimation and error correction improved by boundary conditions make it possible to indicate or calculate the determined values with a higher precision or, alternatively, to use inertial measurement devices that are less expensive, but prone to drift, as the occurring errors can be estimated and corrected.

In particular, buildings and/or large systems such as wind turbines or offshore platforms or the like are often stationary, i.e. installed on a fixed location in the earth fixed inertial system. For such systems support of the navigation algorithm by boundary conditions is possible.

An according support is also possible for non-position fixed structures, if a positioning signal can be used to determine the position of the structure. For example, a receiver of a global navigation satellite system (GNSS) may be used to receive and to evaluate a satellite based signal for position determination, e.g. a GPS-, GLONASS-, Compass- or Galileo-receiver. Alternatively, also a different, for example local optical positioning signal may be used for position determination, or an optical recognition method may be used that analyzes an image captured by a camera. The position determined in this manner can be used to recognize and to correct a drift of sensors, an error of the calculated position and orientation values, or a systematic error of the monitoring value.

The boundary condition may also be predetermined by a constraint of a degree of freedom of movement of at least a part of the structure. For example, during rotation and/or oscillation of a rotor blade a position along the rotor blade and, hence, for example a distance of a point to the center will hardly change. Thus, movements of this point are restricted in its degrees of freedom by the fixation of the rotor blade to the center. This constraint can be used as boundary condition to recognize or to correct, for example, a systematic measurement error of the sensors.

Further, also an inclination angle of at least a part of the structure may be determined as boundary condition. For example, an inclination of a tower of a wind turbine may lead to a shift of the position of an inertial measurement device located in the housing of the wind turbine. If only the known stationary position of the structure is detected to support the navigation algorithm, the translational movement of the inertial measurement device is possibly considered as position drift and a possibly critical inclination of the tower will not be recognized. Taking into account the inclination angle allows recognizing and separated monitoring or correction of position drift and inclination.

Further, the boundary condition may be determined on the basis of a mean value of a movement of at least a part of the structure and/or the inertial measurement device. For example, it is possible that the part of the structure to which the inertial measurement device is mounted is set into oscillations, e.g. by wind load or wave impact. The oscillations change the position of the inertial measurement device and are detected as acceleration. In order to be able to detect nevertheless a zero point error or a systematic drift of the inertial measurement device, a mean value of the movement during a predetermined time period may be fixed and may be used as boundary condition for determining and correcting of measurement errors, for example on the basis of a Kalman filter.

Further, the boundary condition may also be determined on the basis of environmental influences acting on the structure. In particular, environmental influences such as a wind velocity, a wind direction, a current velocity, a current direction and/or a direction of wave impact may, for example, for offshore wind turbines or offshore platforms lead to movements and/or oscillations of the wind turbines or offshore platforms, which are measured by the inertial measurement device attached thereto. Such environmental influences are therefore acting on the determination of position and orientation of the structure and may therefore be mistaken to be a zero point error, i.e. a systematic drift, of the inertial measurement device. However, if during measurement correction the boundary condition determined on the basis of the environmental influences is taken into account, measurement correction will be possible just as well as recognition of the shift of position or orientation of the inertial measurement device.

According to a further embodiment, the system comprises several inertial measurement devices mounted to the structure, wherein the central unit is configured to determine the monitoring value on the basis of a relative movement between any two of the several inertial measurement devices.

Due to the use of several inertial measurement devices it is possible to measure movements or oscillations of the structure at several measurement locations (mounting locations of the inertial sensors). Due to this, a precise detection of relative movements within the structure is possible that allows determining deflections, torsions and/or bending between the measurement locations. Such movements have a direct influence on the material and provide therefore important information for monitoring, for determining maintenance intervals, and/or for estimation of lifetime.

According to a variant the structure may comprise several components coupled to each other, wherein on at least two of the components an inertial measurement device is arranged, respectively.

The arrangement of inertial measurement devices on several components allows monitoring of a relative movements of the components with respect to each other, due to which the movement of the components with respect to each other and hence for example a load of the coupling devices between the components is made detectable.

Several inertial measurement devices may for example be used to monitor a wind turbine with a tower, a housing arranged on top of the tower, and a rotor arranged on the housing, the rotor having rotor blades for driving a generator.

In using several inertial measurement devices arranged on a rotor blade bending of the rotor blade may be detected, for example. Based on this a warning message can be generated and/or an orientation of the rotor blade with respect to the wind can be actively controlled. Due to this, it is possible to recognize and/or to avoid damages.

Further, an orientation of the inertial measurement device mounted on the housing with respect to the inertial measurement device mounted on the tower may be determined. Based on this the orientation of the housing may be evaluated or corrected under consideration of a detected wind direction.

Use of several inertial measurement devices on the structure or at different parts of the structure makes it therefore possible to detect and evaluate movements of the structure in higher modes and to monitor the structure effectively.

According to a further variant the structure is a wind turbine and the inertial measurement device is arranged on a roto blade of the wind turbine. Here, the inertial measurement device may be arranged such that a tangent of a rotation path of the inertial measurement device is orthogonal and/or parallel to none of the detecting directions of the rotation rate sensors (oblique/oblique-angled assembly). Additionally or alternatively the central unit may be configured to determine the boundary condition on the basis of at least one information of the group comprising: gravity acceleration that acts cyclically during a revolution of the rotor onto the inertial measurement device, rotation of the earth that acts cyclically during a revolution of the rotor onto the inertial measurement device, and an output signal of a rotary pulse generator of the rotor.

The oblique assembly of the sensors on the rotor blade ensures that the detection axes or directions are not arranged collinearly to a rotation tangent of the rotor blade. Thus, all measurement axes are comparably subjected to the acceleration or rotation during a revolution of the rotor blade.

Because of the arrangement of the inertial measurement device on the rotor blade the inertial measurement device rotates during operation of the wind turbine together with the rotor blade. Then, gravity acceleration of ±1 g acts cyclically during revolution of the rotor onto the inertial measurement device. In the same way the rotation of the earth acts cyclically during revolution of the rotor onto the inertial measurement device. These influences are reflected in the accelerations and rotation rates detected by the inertial measurement device and hence in the output signal of the inertial measurement device.

Gravity acceleration and rotation of the earth that act cyclically during the revolution of the rotor are superimposed to the output signal and can be detected and compensated in the output signal. In particular, they may be used as boundary conditions for the error correction described above. Here, it is possible to detect, estimate, or compensate systematic errors of the inertial measurement device, in particular of a gyroscope scale factor error of the inertial measurement device. Due to this, an increase of the error by means of the gyroscope scale factor error can be prevented.

Such an error correction may in particular be used during calibration of the sensors. The oblique assembly of the inertial measurement device on the rotor blade allows calibrating all measurement axes or the corresponding sensors in this manner.

Alternatively or additionally also the output signal of a rotary pulse generator of the rotor may be used to detect the revolution of the rotor and to evaluate on this basis the influence of the gravity acceleration or the rotation of the earth on the measurement result and to calibrate the inertial measurement device.

According to a further embodiment, the structure is also a wind turbine. The inertial measurement device is arranged on a housing of the wind turbine. Further, the central unit is configured to determine the boundary condition on the basis of a rotary encoder of the housing.

For example, the rotary encoder may be installed on the coupling location of tower and housing. The output signal of the rotary encoder can be compared to an output signal of the inertial measurement device and may be used as boundary condition for error estimation or calibration of the inertial measurement device. Due to this, a gyroscope scale factor of the inertial measurement device can be detected or corrected. Consecutively, an orientation of the housing in azimuth direction can be detected and adapted, for example with regard to a wind direction. This allows an optimal use of wind energy. According to a further embodiment the central unit is configured to determine the monitoring value on the basis of at least one information of the group comprising: an output value of a mathematical model of the structure, a status information of the structure, an environmental parameter, a rotation rate, an acceleration, an angular velocity, a velocity, an orientation and/or a position at a location of the structure different from the installation location of the inertial measurement device, an amplitude and/or a frequency of movement of an oscillation of the structure, and a torsion between two different locations of the structure.

In particular, it is possible to input the acceleration and rotation rate values measured by the inertial measurement device for example into a mathematical model that is for example generated on the basis of finite elements and reflects the physical conditions of the structure, and which can be stored on a storage. For example, the central unit may input the measurement values by accessing the storage and may successively calculate on the basis of the measurement values a dynamic behavior of the structure. Due to this, the mathematical model is stimulated and the dynamic behavior (movements, oscillations) of the structure is simulated.

Alternatively or additionally status information of the structure such as an operation parameter such as a gear setting and/or a generated energy of the wind turbine may be used for determining the monitoring value. Also this information may be input into the mathematical model of the structure or may be compared to the simulated dynamic behavior of the mathematical model. In this way they may on the one hand be used for stimulating of the mathematical model and on the other hand for validating the mathematical model.

For example, as environmental parameter for determining the monitoring value (satellite based) positioning signals regarding the position of at least a part of the structure, an orientation of the housing, a rotation angle of the rotor, a pitch of the rotor blades, a wind direction and wind strength, a wave direction and wave strength, a current, a temperature and a power output of, for example, a wind turbine may be considered. For example, information concerning a measured wind direction may be used to evaluate or correct an orientation of the housing in azimuth direction.

Further, the central unit may be configured to determine movements of a location of the structure that differs from the installation location of the inertial measurement device. This may be achieved by inputting three-dimensional rotation rates and accelerations into the mathematical model, wherein the rotation rates and accelerations are measured by one or several inertial measurement device(s) with installation locations different from said location of the structure. Based on this, it is possible to calculate also movements on further locations of the structure. For example, torsions between two different locations of the structure, e.g. between two different locations of a rotor blade or a tower, and hence mechanical loads of the structure can be detected. In this manner movements with higher modes can be determined or calculated. This allows an effective modelling and monitoring of movements and oscillations of the complete structure.

Further, the monitoring value may be determined on the basis of an amplitude and/or a frequency of movement of an oscillation of the structure. In particular, based on the measured, for example three-dimensional, acceleration values oscillations of the structure or of its parts and hence the structure-borne sound of the structure can be detected. This allows recognizing of mechanical damages on the structure, e.g. on the drive section of a wind turbine (e.g. fractures and wear-out of the gearing, of the sprockets, and/or in the bearings which leads to changes of the structure born sound).

By means of an analysis of the structure-borne sound on the basis of inertial measurement devices arranged on the rotor blades icing on or cracks of the rotor blades can, for example, be detected and according maintenance measures can be initiated.

According to a further variant the central unit may be configured to capture a threshold value of the monitoring value and to transmit after exceeding of at least one of the threshold values information to the output unit. It may further be configured to transmit on the basis of the monitoring value a proposal for actuation variables for adjusting of actuators on the structure to the output unit. Alternatively or additionally the central unit may be configured to transmit the actuation variables to the actuators based on the monitoring value.

This variant allows a plurality of monitoring possibilities ranging from a threshold monitoring and threshold exceeding message and determining of control proposals to an active regulation of the dynamic behavior of the structure.

This allows recognizing and notifying imminent damages. In the context of maintenance of wind turbines recognizing and notifying of icing, of imbalance of the rotor, or of gear damages allows a secure operation and recognizing of need for maintenance and upkeep.

Further, the maintenance personnel may be supported by outputs of the output unit, for example by generating proposals for controlling of the wind turbine. For example, a modification of the orientation of rotor blades or a modification of gear settings can be proposed. By this means damages can be avoided and a better utilization can be obtained.

In addition, the central unit may transmit, besides the output of the monitoring value, actuating variables to actuators of the structure. This allows to react quickly to a critical state detected based on the monitoring value and allows, for example, moving, after a damage of the gearings, the rotor blades quickly and actively out of the wind. Further, a control of the power output that is adapted to existing needs and conserves at the same time the material can be realized.

Depending on a level of criticality of the determined monitoring value the transmission of actuating variables to the actuators may depend on a human confirmation by maintenance personnel.

A method for monitoring of movements of a structure comprises detecting of rotation rates and acceleration values in the earth fixed inertial system of at least one inertial measurement device mounted on the structure, determining of a monitoring value on the basis of the rotation rates and the acceleration values by means of a navigation algorithm, and outputting of the monitoring value.

The method may for example be carried out in any arbitrary embodiment of the system described above.

According to a variant the method may comprise inputting of the rotation rates and acceleration values into the mathematical model of the structure, validating the mathematical model based on a comparison of the evolution of the measured rotation rates and acceleration values, respectively, with rotation rates and acceleration values calculated by the model and determining the monitoring value on the basis of the mathematical model.

This method allows to stimulate the mathematical model for example with the measurement values and to calculate on the basis of the stimulation the dynamical behavior of the model, for example stepwise during a predetermined time period. Corresponding measurement values of the acceleration and rotation rate sensors of the inertial measurement device(s) can be detected during the corresponding time period in parallel. By a comparison of the detected and the calculated rotation rates or of the angular velocity, velocity, orientation or position that can be or are calculated on the basis of the rotation rates, the mathematical model can be validated.

For example, the mathematical model can be considered to be suitable, if deviations are always less than a predetermined threshold. If this is not the case, a need for adapting the mathematical model or the calculation method can be recognized. On the basis of the validated mathematical model the monitoring value can be determined and output.

According to a further variant of the method the structure may comprise at least a part of a wind turbine with a rotor and rotor blades, wherein the inertial measurement device is arranged on one of the rotor blades. The method may comprise calibrating of the inertial measurement unit on the basis of gravity acceleration that acts cyclically during a revolution of the rotor onto the inertial measurement unit, on the basis of the rotation of the earth that acts cyclically during a revolution of the rotor onto the inertial measurement device, and/or on the basis of a rotary encoder of the rotor (according to the manner described above).

For an oblique assembly of the inertial measurement device(s) on one of the rotor blades the zero point error and the gyroscope scale factor of the inertial measurement device can be estimated and corrected during calibration. This method can in particular be helpful during initializing of the wind turbine.

According to a further variant the structure comprises at least a part of a wind turbine with a rotor with rotor blades, wherein the inertial measurement device is arranged on the rotor. The method comprises detecting an imbalance of the rotor on the basis of the detected rotation rates and acceleration values.

This method can in particular be used for balancing of the rotor. Imbalances can be detected and corrected, which allows an effective and fatigue-poof operation of the wind turbine.

These and further features of the invention will be discussed based on examples under consideration of the accompanying figures in what follows.

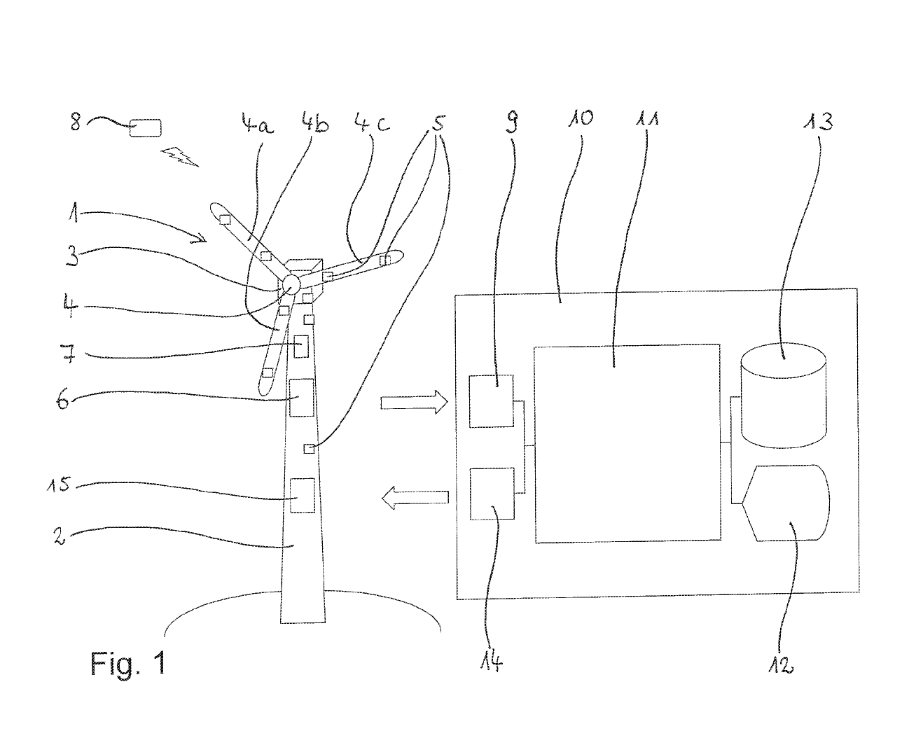

FIG. 1 illustrates a system for monitoring a wind turbine on the basis of measurement results of several inertial measurement devices by means of a navigation algorithm; and

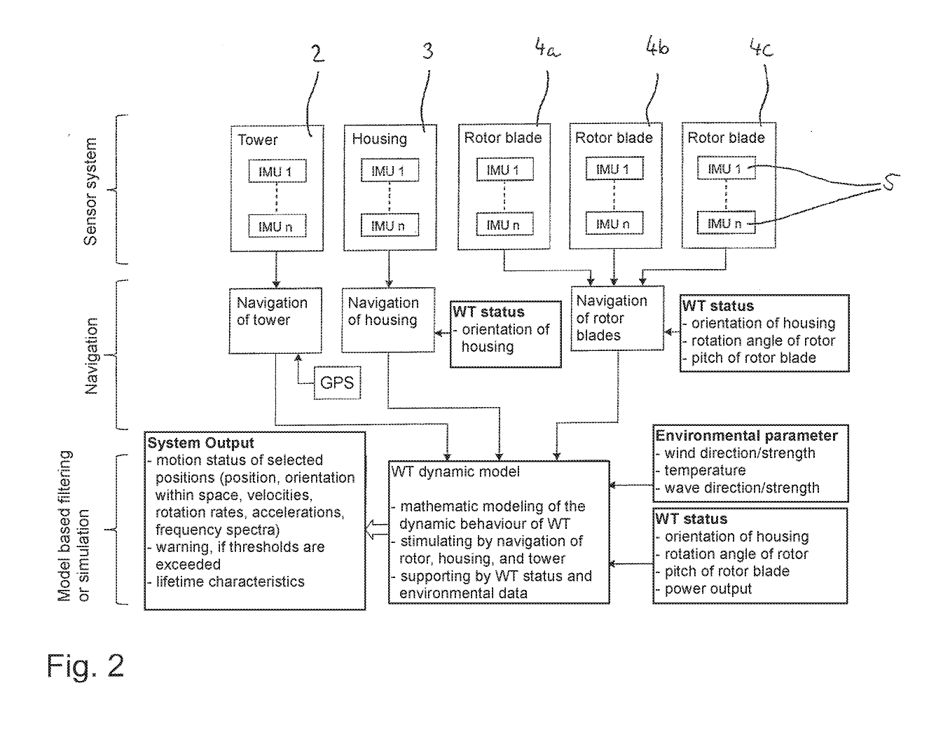

FIG. 2 illustrates a schematic diagram of a system for monitoring a wind turbine on the basis of a mathematical model.

FIG. 1 illustrates a system for monitoring of movements of a wind turbine 1 constituting a structure.

The wind turbine 1 comprises a tower 2, which is erected on ground, and on which a housing 3 with a thereon provided rotor 4 with rotor blades 4a, 4b and 4c is arranged. On the wind turbine 1 or its components 2, 3, 4, 4a, 4b and 4c one or several inertial measurement devices 5 are arranged, respectively. These are illustrated in the drawing by small boxes and are not separately referred to with reference signs for clarity reasons.

The inertial measurement devices 5 comprise each three rotation rate sensors that have detection axes that are linearly independent of each other and/or orthogonal to each other as well as three acceleration sensors having each detecting directions that are linearly independent of each other and/or orthogonal to each other. Their output signal may be used to determine by means of a navigation algorithm, for example known from vehicle, ship, or flight navigation, a calculation of angular velocities and velocities or orientations and positions of the respective inertial measurement devices 5 in the earth fixed inertial system.

As basis for such calculations a transmission unit 6 collects the values measured by the inertial measurement devices 5 as well as, if necessary, environmental parameters and status information of the wind turbine measured by a further sensor unit 7. The environmental parameters may refer, for example, to a wind direction, a wind strength, a temperature, a wave direction, and/or wave strength (e.g. for offshore structures). The status information may refer to a status of the wind turbine and comprise for example an orientation of the housing 3, a rotation angle of the rotor 4, a pitch or a bending of the rotor blades 4a, 4b, 4c and a power output of the generated energy. Further, the status information may also comprise, for example, a positioning signal received from a satellite 8, which may be received from the sensor unit 7 and be transmitted to the transmission unit 6.

The collected data may, for example, be sent from the transmission unit 6 by means of wireless or wire-bound communication to a receiver 9 of a monitoring device 10. The monitoring device 10 may be located locally in a surrounding of the wind turbine 1, but may also be located remotely from the wind turbine 1. A local arrangement of the monitoring device 10 may also include an arrangement within or on the wind turbine 1 or an arrangement in its nearby surroundings. For example, the monitoring device 10 may be provided in a monitoring and control center of a wind farm that includes the wind turbine 1. An arrangement remote from the wind turbine 1 is for example advantageous for offshore wind turbines.

The monitoring device 10 may comprise a central unit 11 for determining of the monitoring value on the basis of the transmitted data, in particular, on the basis of the rotation rates and acceleration values measured by the inertial measurement devices 5. For example, the central unit 11 may carry out a classical navigation algorithm with Schuler compensation.

Due to this, each of the inertial measurement devices can calculate an angular velocity and a velocity of a movement, and a position and orientation within space. Further relative movements of the inertial measurement devices with respect to each other can be determined and evaluated. Based on this, a monitoring value can be determined, for example a pitch of one of the rotor blades 4c or a torsion of the tower 2 caused by wind load.

The monitoring value may be sent to an output unit 12, which makes available or indicates the monitoring value, for example to operating personnel. Alternatively the monitoring value may also be captured in a storage 13 and stored for documentary purposes.

For the use of classical navigation algorithms for monitoring of the movements of the structure there is the possibility to include restrictions and conditions, which result from structural characteristics of the structure, into the navigation algorithm and in particular into an error estimation or error correction.

In particular, errors are typically superimposed to the measurement values of the inertial measurement devices 5, which are based for example on a zero point error or scale factor error of the used acceleration and rotation rate sensors. During determination of the directional and angular velocities or the position and the orientation these errors are integrated and lead to a progressional drift.

For the monitoring of structures physical conditions of the structure may be considered as boundary conditions for the navigation algorithm and may be taken into account in the context of error correction, for example by means of a Kalman filter. Such boundary conditions are for example a (geographic) position of the structure, which is fixed in principle for buildings or for structures built on solid ground. For offshore structures the position may for example be determined by means of a satellite based positioning signal (GPS). Further, boundary conditions may also be determined as described above from environmental information or by means of further sensors, for example by means of a tower inclination sensor.

The boundary conditions allow estimating and correcting systematic errors of measurement results of the inertial measurement devices. Due to this, a precise determination of position and orientation becomes possible, which provides a useful basis for determining the monitoring value. Further boundary conditions that may lead to an improvement of error estimation and correction have already been described above and may be used in the embodiment illustrated in FIG. 1.

Further, the central unit 11 of the monitoring device 10 may be configured to capture threshold values of the monitoring value and to send information to the output unit 12, if at least one of these thresholds is exceeded. Pre-setting of thresholds allows detecting and notifying of imminent damages as well as of a need for maintenance and regulation.

The central unit 11 may also make on the basis of the monitoring value a proposal for actuating variables for adjusting actuators of the wind turbine 1. Such proposals may be indicated to the operation personnel for example by the output unit 12. They may, for example, comprise orienting of the housing 3 according to a detected wind direction, orienting of the rotor blades with regard to an output to be generated, and/or a shutdown of the wind turbine, for example because of imminent damages or in case of damage.

Further, the central unit 11 may transmit the actuating variables via a transmission unit 14 to a receiving unit 15 of the wind turbine 1. In the wind turbine 1 the received actuating variables may be used to control actuators of the wind turbine accordingly, and to initiate for example rotating of the housing 3 or orienting of the rotor blades 4a, 4b, 4c.

Further, the central unit 11 may, for example, determine the monitoring value on the basis of a mathematical model that calculates a dynamical behavior of the wind turbine 1 and may, for example, be stored in the storage 13. The rotation rates and accelerations measured by the inertial measurement devices 5 or the velocities, angular velocities, positions and orientations determined therefrom may be input into the mathematical model, which calculates, simulates, or dynamically represents based thereon the dynamic behavior of the wind turbine.

Also the further data measured by the sensor unit 7 and transmitted by the transmission unit 6 such as environmental parameters and status information may be used for stimulating the model.

The calculated dynamical behavior may be tested and evaluated against the background of further measurement values of the inertial measurement devices 5 or further status information such that these values allow in parallel stimulating and supporting of the mathematical model.

The mathematical model may for example be used to detect and to evaluate movements of the wind turbine 1 with higher modes, such as for example torsions of the tower 2 or bending of the rotor blades 4a, 4b, 4c.

A level of detail of the calculation steps of the mathematical model may be determined in respect of the desired computational accuracy and the available computational power. If the monitoring device 10 and in particular the central unit 11 has sufficient computing capacity, the calculation and evaluation may be carried out substantially under real-time conditions or with only little delay.

During operation the system for monitoring the wind turbine or the monitoring method implemented therein may be used as condition monitoring system by comparing the determined movements, oscillations, frequencies and/or amplitudes with predetermined thresholds. In the context of condition monitoring warnings may be output, if the thresholds are exceeded.

Further, the measurement and calculation values may be considered as control variables that allow optimal adjustment of the wind turbine 1 on the one hand with respect to the acting forces and on the other hand with respect to the power to be output. This allows a good utilization in parallel with a material conserving operation.

An evaluation of changes in load and of different loads during an extended period allows determining of a residual lifetime of the wind turbine 1 or its components, and/or planning of maintenance measures.

As already indicated above, the measurement and calculation values may also be used during development and testing of structures as well as during initiation, to detect and correct, for example, excessive loads or imbalances.

FIG. 2 shows a schematic diagram of an embodiment of a monitoring system, for example the monitoring system of FIG. 1.

In the passage above the sensors and their arrangement are described. Accordingly the tower 2, the housing 3 and the rotor blades 4a, 4b, 4c comprise each n inertial measurement devices (IMU: inertial measurement unit), which are mounted at different positions of the respective components, respectively.

The inertial measurement devices 5 send their data to navigation units of the respective components that are illustrated in the middle part of FIG. 2, inside of which navigation calculations on the basis of the navigation algorithm are carried out. Here, for example the velocities, angular velocities, positions and orientations of the inertial measurement devices can be determined. Navigation is supported, respectively, by suitable additional data or boundary conditions of the structure, for example by a GPS signal, an orientation of the housing, a rotation angle of the rotor, and/or a pitch of the rotor blades. As described above, this information can be used, for example, for error estimation, error correction, and/or sensor calibration.

The lower part of FIG. 2 illustrates model based filtering of the data, into which the results of the navigation calculation as well as further environmental parameters (wind direction, wind strength, temperature, wave direction, wave strength) and status information (orientation of housing, rotation angle of rotor, pitch of rotor blades, output of power) of the wind turbine 1 are input. In this process, the data may be processed continuously and substantially in real-time. The model based filtering can therefore correspond to a simulation that allows model supported evaluation of the data “on-line”, i.e. without delay, for example according to possibly preset real-time conditions.

In the context of model supported filtering a mathematical model of the wind turbine is used to calculate the dynamic behavior of the wind turbine 1. As described above the navigation data can stimulate, support, and validate the model. The model supported filtering gives as output, for example, information regarding the movement state of selected positions, warnings after exceeding of predefined thresholds, and/or lifetime characteristics. These results may for example be sent to the output unit 12 to make them accessible to the operation personnel. In fact, this may be done in the context of condition monitoring, of maintenance planning, and/or in the context of an active regulation of the wind turbine 1.

As a result, using inertial measurement systems and classical navigation algorithms in the field of building and facility monitoring may allow an effective monitoring and regulating of the respective structure. The boundary conditions valid for such buildings and facilities can be used to estimate and compensate errors that occur typically in the context of inertial navigation (zero point and scale factor errors). Based on this, on the one hand an effective and on the other hand a facility conserving operation of wind turbines, and a maintenance planning optimized with respect to cost can be achieved.

1. System for monitoring of movements of a structure comprising:
at least one inertial measurement device mounted to the structure for detecting of rotation rates and acceleration values in the earth fixed inertial system,
a central unit for determining a monitoring value on the basis of the rotation rate and acceleration values by means of a navigation algorithm, and
an output unit for outputting of the monitoring value.

2. System according to claim 1, wherein
the inertial measurement device comprises three detection axes that are each independent of each other and/or orthogonal to each other as well as three detecting directions that are each linearly independent from each other and/or orthogonal to each other.

3. System according to claim 1, wherein
the central unit is configured to determine and/or correct a measurement error of the inertial measurement device on the basis of a boundary condition predetermined by the structure.

4. System according to claim 1, wherein
the central unit is configured to determine the boundary conditions on the basis of at least one information of a group comprising
a substantially stationary position of the structure,
a position of at least a part of the structure determined on the basis of a satellite based positioning signal,
a constraint of a degree of freedom of a movement of at least a part of the structure,
an inclination angle of at least a part of the structure,
a mean value of a movement of at least a part of the structure and/or of the inertial measurement device, and
an environmental influence acting on the structure.

5. System according to claim 1, having
several inertial measurement devices mounted to the structure, wherein
the central unit is configured to determine the monitoring value on the basis of a relative movement between at least any two of the several inertial measurement devices.

6. System according to claim 1, wherein
the structure comprises several components (2, 3, 4, 4a, 4b, 4c) that are coupled to each other, and wherein
one inertial measurement device is mounted on at least two of the components (2, 3, 4, 4a, 4b, 4c), respectively.

7. System according to claim 1, wherein
the structure is a wind turbine and the inertial measurement device is arranged on a rotor blade (4a, 4b, 4c) of the wind turbine, wherein
the inertial measurement device is arranged such that a tangent of a path of rotation of the inertial measurement device is not perpendicular and/or parallel to any of the detecting directions of the rotation rate sensors, and/or
the central unit is configured to determine the boundary conditions on the basis of at least one information of the group comprising
gravity acceleration acting cyclically during a revolution of the rotor onto the inertial measurement device,
the rotation of the earth acting cyclically during a revolution of the rotor onto the inertial measurement device, and
an output signal of a rotary pulse generator of the rotor.

8. System according to claim 1, wherein
the structure is a wind turbine and the inertial measurement device is arranged on a housing of the wind turbine, and
the central unit is configured to determine the boundary condition on the basis of a rotary encoder of the housing.

9. System according to claim 1, wherein
the central unit is configured to determine the monitoring value on the basis of at least one information of the group comprising
an output value of a mathematical model of the structure,
a status information of the structure,
an environmental parameter,
a rotation rate, an acceleration, an angular velocity, a velocity, an orientation, and/or a position of a location of the structure different from an installation location of the inertial measurement device,
a torsion between two different locations of the structure, and
an amplitude and/or frequency of movement of an oscillation of the structure.

10. System according to claim 1, wherein
the central unit is configured to
capture threshold values of the monitoring value and to send information to the output unit, if at least one of the threshold values is exceeded,
send on the basis of the monitoring value a proposal for actuating variables for adjusting of actuators of the structure to the output unit, and/or
send on the basis of the monitoring value the actuation variables to the actuators.

11. Method for monitoring of movements of a structure comprising:
detecting of rotation rates and acceleration values in the earth fixed inertial system of at least one inertial measurement device mounted to the structure,
determining of a monitoring value on the basis of the rotation rates and acceleration values by means of a navigation algorithm,
outputting of the monitoring value.

12. Method according to claim 11, comprising:
inputting of rotation rates and acceleration values into a mathematical model of the structure,
validating of the mathematical model based on a comparison of the evolution of the measured rotation rates and acceleration values with rotation rates and acceleration values, respectively, that are calculated with the model, and
determining the monitoring value on the basis of the mathematical model.

13. Method according to claim 11, wherein the structure comprises at least a part of a wind turbine having a rotor with rotor blades (4a, 4b, 4c), and wherein the inertial measurement device is arranged on one of the rotor blades (4a, 4b, 4c), comprising:
calibrating the inertial measurement device on the basis of gravity acceleration that acts cyclically during a revolution of the rotor onto the inertial measurement device, on the basis of the rotation of the earth that acts cyclically during a revolution of the rotor onto the inertial measurement device, and/or on the basis of a rotary encoder of the rotor.

14. Method according to any claim 11, wherein
the structure comprises at least a part of a wind turbine having a rotor, and wherein the inertial measurement device is arranged on the rotor, comprising
detecting an imbalance of the rotor on the basis of the detected rotation rates and acceleration values.
